(19) United States
(12) Patent Application Publication
(10) Pub. No.: US 2024/0271025 A1
(43) Pub. Date: Aug. 15, 2024

(54) LOW GLOBAL WARMING REFRIGERANT BLENDS

(71) Applicant: RPL Holdings Limited, Altrincham (GB)

(72) Inventors: John Edward Poole, Altrincham (GB); Richard Llewellyn Powell, York (GB)

(21) Appl. No.: 18/567,340

(22) PCT Filed: Jun. 6, 2022
(86) PCT No.: PCT/EP2022/065306

§ 371 Date: Dec. 5, 2023

(30) Foreign Application Priority Data
Jun. 6, 2021 (GB) 2108077.5

(51) Int. Cl. C09K 5/04

(52) U.S. Cl. CPC C09K 5/045; C09K 2205/106; C09K 2205/122; C09K 2205/126; C09K 2205/22; C09K 2205/40

(57) ABSTRACT

A refrigerant composition comprising: Carbon dioxide 1-7%, Hydrofluoroolefin (HFO)-1234ze(E) 70-97%, HFC-227ea 2-16%; and 0-27% of an optional component selected from the group consisting of: HFC-32, HFC-134a, R125 and mixtures thereof, wherein the percentages of the components are by mass and are selected from the ranges quoted to total 100%.

This invention relates to refrigerant compositions which can be used in thermal pumps designed to pump heat from a lower temperature to a higher temperature by the input of work. When such devices are intended to generate lower temperatures, they are typically called refrigerators or air conditioners. Where they are intended to produce higher temperatures, they are typically termed heat pumps. The same device may supply heating or cooling depending upon the user's requirement. This type of thermal pump may be called a reversible heat pump or reversible air conditioner.

HFC-134a was introduced as a non-ozone depleting, non-flammable, low toxicity replacement for CFC-12. It has proven an efficient refrigerant for major applications, including mobile air conditioning, medium temperature refrigeration and chillers. However, as the concern over the contribution of fluorinated refrigerants to global warming has grown, the EU and other territories have imposed global warming potential (GWP) quotas and/or taxes to progressively reduce the availability of fluorinated refrigerants considered to have excessively high GWPs.

In this specification the numerical value for Global Warming Potential (GWP) refers to an Integrated Time Horizon (ITH) of 100 years as contained in the Inter-Governmental Panel on Climate Change Fourth Assessment Report (AR4).

Driving the phase-down of HFCs by imposing a progressively strict annual GWP quota has two key consequences. Firstly, shortages of these refrigerants available to service existing equipment and charge new equipment will disrupt the refrigeration and air conditioning industries. Secondly, the price of remaining refrigerant rapidly increases as supply can no longer meet demand. Without replacement refrigerants, critical equipment, e.g., for preserving food in supermarkets and air-conditioning in hospitals, may stop functioning with dire social repercussions. The European GWP quota especially hits the high GWP refrigerant blends, R404A/R507A (low temperature, supermarket refrigeration) and R410A (room air conditioning), but HFC-134a, while having a lower GWP than R404A/507a, has a significant GWP & has been phased out in the EU for use in new motor vehicle air-conditioners because of this comparatively high GWP. However, HFO-1234yf, which has replaced R134a in new vehicles in the EU, is flammable with a safety classification of A2L from ASHRAE & not permitted for retrofitting R134a in existing systems. This invention can replace R134a in existing vehicles with a substantially reduced GWP between 100 and 500.

Having a lower GWP of 1430, HFC-134a might be considered less badly affected. But this view is too simplistic. Replacing HFC-134a by a lower GWP product frees up quota for R404A, and especially R410A for which no lower non-flammable (according to ASHRAE Standard 34) GWP alternative is available. A lower GWP replacement for R134a would thus allow the refrigeration and air conditioning industries to better manage the phase-down of HFCs without disrupting the vital services they support.

This invention therefore relates to low GWP blends, which, particularly but not exclusively, are retrofit replacements for HFC-134a in existing refrigeration and air-conditioning systems to ensure their continued operation, while providing sufficient quantities of refrigerants to supply the market demand and minimising the cost to the user. Also, the blends have no adverse effect on stratospheric ozone, i.e., they have zero Ozone Depletion Potentials. In this specification “retrofit” refers to the essentially complete replacement of the HFC-134a charge in an existing unit.

According to the present invention a refrigerant composition comprises:
Carbon dioxide 1-7%
Hydrofluoroolefin (HFO)-1234ze 70-97%,
HFC-227ea 2-16%; and
0-27% of an optional component selected from the group consisting of
HFC-32, R125 and mixtures thereof,
wherein the percentages of the components are by mass and are selected from the ranges quoted to total 100%.

In embodiments, the minimum amount of the one or more optional components may be 0.6%, preferably about 1%.

In preferred embodiments of this invention the compositions consist essentially of the recited components, including optional components, so that any additional ingredients or impurities are not present to a sufficient extent to affect the essential properties of the refrigerant composition.

Particularly preferred embodiments consist of the recited components so that no further ingredients are present.

Preferred compositions have direct GWPs which are less than 500, and more preferably less than 300.

The compositions of this invention may be capable of replacing HFC-134a in refrigerant equipment.

This invention relates particularly, but not exclusively to refrigerant compositions that have GWPs in the range 100 to 500, i.e., significantly lower than that of HFC-134a; have an ASHRAE safety classification of A1 (low toxicity/non-flammable); possess energy efficiencies and cooling capacities at least comparable to HFC-134a; and have a maximum operating pressure not greater than 2 bar above that of HFC-134a at a mean condensing temperature of 45° C. For existing equipment, where there is little scope for carrying out physical modifications, non-flammability (A1) is essential.

This invention specifically relates to compositions comprising carbon dioxide, HFO-1234ze(E), HFC-227ea and optionally HFC-32, HFC-134a and HFC-125. These compositions may combine appropriate vapour pressures for formulating low toxicity, non-flammable HFC-134a retrofit replacements. The invention may provide compositions where the flammability of the HFO-1234ze(E) and HFC-32 can be suppressed, by the presence of the non-flammable components: carbon dioxide, HFC-125 and HFC-227ea. Conversely, the relatively high GWPs of HFC-125 and HFC-227ea and the moderate GWP of HFC-32 may be offset by the very low GWPs of carbon dioxide and the HFOs.

Exemplary embodiments of this invention provide retrofit refrigerant compositions that allow equipment to continue operating at HFC-134a pressures, by ensuring that sufficient quantities of replacement refrigerants are available for servicing existing equipment and for charging new equipment as the quantities of HFCs progressively decline. This may be achieved with compositions having GWPs not exceeding 500. The reduced EU GWP quota may provide adequate latitude for compositions, disclosed in this specification, with thermodynamic and flammability properties that enable them to be retrofitted into existing designs of HFC-134a equipment with few or no modifications, minimising the cost to the equipment owner.

While hydrocarbons, ammonia and carbon dioxide are technically feasible refrigerants for refrigeration and air-conditioning systems and have considerably lower GWPs than HFCs, they are not direct replacements for HFC-134a, since they have inherent disadvantages that work against their general usage, particularly in public areas such as supermarkets. Highly flammable hydrocarbons can only be used safely in conjunction with a secondary refrigeration circuit, which reduces energy efficiency and increases costs, or with small charges, which severely limits the maximum cooling duty for which they can be used. Even when such safety precautions have been taken hydrocarbon refrigerants have caused building damage, injury and death. Carbon dioxide must be used in the transcritical state on the high-pressure side of the system to allow heat rejection to ambient air. Pressures are often in excess of 100 bar, again resulting in an energy penalty and also a significantly higher capital cost compared to conventional HFC-134a systems. Ammonia is markedly toxic with leaks from industrial refrigeration installations regularly causing deaths and injuries. Because of these adverse properties, hydrocarbons, ammonia and carbon dioxide cannot be retrofitted into existing HFC-134a units.

As the availabilities of high GWP HFCs, including HFC-134a, become constrained by the EU F-Gas regulations, and similar legislation globally following the ratification of the Kigali Amendment to the Montreal Protocol, insufficient quantities of these refrigerants will be available to service existing equipment. In another embodiment of this invention, surprisingly, we have found that compositions, claimed in this specification, with GWPs less than 500, can be also used to top-up an HFC-134a-containing unit at the annual service. Advantageously, changes in performance are minimised because the residual HFC-134a is still the major component in the resulting mixture, thus enabling the equipment to continue operating for at least 5 years, despite a commercial refrigeration unit typically losing 5 to 20% of its refrigerant charge each year. Although not illegal in many countries, the mixing of different refrigerants within equipment is not generally condoned at present, but as refrigerant costs rise because of high taxes and the reduced availability of HFCs, topping-up will become economically attractive. When employed in this way, blends may be termed “extenders” when they are used to partially replace the HFC-134a charge, rather than replace the whole charge when they are termed “retrofits”. A further embodiment of this invention may provide extenders with GWPs less than 500, and preferably less than 300. The availability of these novel compositions thus enables the continued use of existing installations thereby avoiding the high costs of prematurely replacing equipment, which is still functioning.

HFC-227ea has a relatively high GWP of 3220 but is non-flammable and tends to co-distil with HFO-1234ze(E) thus enabling the formulation of non-flammable blends. However, adding more HFC-227ea beyond the quantity required for non-flammability increases the blend GWP, which is counter to the object of this invention. Furthermore, blends of HFC-227ea and HFO-1234ze(E) have higher boiling points than R134a and thus lower vapour pressures so that their suction specific capacities may be too low to be acceptable R134a replacements. Carbon dioxide increases the vapour pressure of the blends and thus their capacities, and also maintains non-flammability. However, blends containing more than 6%, for example more than 7% carbon dioxide have high condensing pressures, and thus exceed the pressure ratings of equipment designed for HFC-134a, so are not suitable as replacements. These blends also have large temperature glides which can only be accommodated by operating at higher mean condensing pressures and lower mean evaporating temperatures compared to HFC-134a, leading to poorer energy efficiency.

HCFC-32 may be used in place of some of the carbon dioxide to reduce the temperature in the blends while providing higher capacities, but this introduces a second flammable component. The flammability of HFC-32 can be suppressed by also including an approximately similar mass of HFC-125. But both components have significant GWPs so the quantities of each added should not exceed 6%.

An embodiment of this invention provides a refrigerant composition capable of replacing HFC-134a comprising:
Carbon dioxide 1-6%
R1234ze(E) 75-95%
R227ea 5-15%; and
0-19% of an optional component selected from the group consisting of:
HFC-32, HFC-134a, R125 and mixtures thereof, wherein the percentages of the components are by mass, and are selected from the ranges quoted to total 100%.

Another embodiment of this invention provides a refrigerant composition comprising:
Carbon dioxide 2-6%
R1234ze(E) 77-94%
R227ea 5-13%; and
0-16% of an optional component selected from the group consisting of:
HFC-32, HFC-134a, R125 and mixtures thereof, wherein the percentages of the components are by mass, and are selected from the ranges quoted to total 100%.

An especially preferred embodiment of this invention provides a refrigerant composition comprising:
Carbon dioxide 2-6%
R1234ze(E) 80-93%
R227ea 7-13%; and
0-11% of an optional component selected from the group consisting of:
HFC-32, HFC-134a, R125 and mixtures thereof, wherein the percentages of the components are by mass, and are selected from the ranges quoted to total 100%.

An exemplary embodiment of this invention provides a refrigerant composition comprising:
Carbon dioxide 2-5%
R1234ze(E) 80-93%
R227ea 7-12%; and
0-11% of an optional component selected from the group consisting of:
HFC-32, HFC-134a, R125 and mixtures thereof, wherein the percentages of the components are by mass, and are selected from the ranges quoted to total 100%.

A further exemplary composition comprises:
Carbon dioxide 2-6%
Hydrofluoroolefin (HFO)-1234ze 80-95%,
HFC-227ea 7-14%; and
0-11% of an optional component selected from the group consisting of:
HFC-32, HFC-134a, R125 and mixtures thereof, wherein the percentages of the components are by mass, and are selected from the ranges quoted to total 100%.

Preferred compositions of this invention have direct GWPs which are less than 500, and preferably less than 300.

A further exemplary composition comprises:
Carbon dioxide 3-6%
Hydrofluoroolefin (HFO)-1234ze 89-90%,
HFC-227ea 7-13%; and
wherein the percentages of the components are by mass and are selected from the ranges quoted to total 100%.

A further exemplary composition comprises:
Carbon dioxide 3-6%
Hydrofluoroolefin (HFO)-1234ze 81-89%,
HFC-227ea 8-13%; and
wherein the percentages of the components are by mass and are selected from the ranges quoted to total 100%.

For applications where small glides are preferred at the expense of GWPs above 300 but still below 500 then the composition may comprise:
Carbon dioxide 1-3.5%
Hydrofluoroolefin (HFO)-1234ze 75-93%
HFC-227ea 7-12%
HFC-32 1-5%
HFC-125 1-5%
HFC-134a 1-5%
wherein the percentages of the components, including any optional components, are by mass, and are selected from the ranges quoted to total 100%.

Exemplary compositions consist of the following:
(a) Carbon dioxide 3.5%
   R1234ze(E) 88.5%
   R227ea 8%
(b) Carbon dioxide 5%
   R1234ze(E) 87%
   R227ea 8%
(c) Carbon dioxide 5%
   R1234ze(E) 86%
   R227ea 9%
(d) Carbon dioxide 5%
   R1234ze(E) 85%
   R227ea 10%
(e) R125 3%
   R1234ze(E) 83%
   R227ea 11%
   R32 3%
(f) R125 3%
   Carbon dioxide 2%
   R1234ze(E) 81%
   R227ea 11%
   R32 3%
(g) Carbon dioxide 3.5%
   R1234ze 84.5%
   R227ea 12%
(h) Carbon dioxide 2%
   R1234ze 82%
   R227ea 6%
   R125 3%
   R32 2%
   R134a 5%
(i) Carbon dioxide 1%
   R1234ze 83%
   R227ea 6%
   R125 2%
   R32 3%
   R134a 5%
(j) Carbon dioxide 5%
   R1234ze 86%
   R227ea 9%
(k) Carbon dioxide 5%
   R1234ze 85%
   R227ea 10%
(l) Carbon dioxide 5%
   R1234ze 84%
   R227ea 11%

Preferred compositions have direct GWPs which are less than 500 and more preferred less than 300.

Each blend that is the subject of this invention may be used in a thermal pump lubricated by an oxygen containing oil, for example polyolester (POE) or polyalkyleneoxide (PAO), or by such oils mixed with a hydrocarbon lubricant up to 50%, for example a mineral oil, alkyl benzene or polyalpha-olefin.

Percentages and amounts referred to in this specification are by mass, unless indicated otherwise and are selected from any ranges quoted to total 100%.

The invention is further described by means of examples but not in a limitative sense, with reference to the following Examples:

### EXAMPLE 1

As a comparative example, an air conditioning unit containing HFC-134a and operating on a Rankine cycle with an hermetic compressor was modelled using a cycle based on NIST's REFPROP 10.0 database. The cycle input parameters were the following:
Condensing temperature 45° C.
Liquid subcool 5K
Evaporating temperature 7° C.
Suction super heat 5K
Compressor isentropic efficiency 0.75
Motor efficiency 0.9

The results are summarised in Column 1, Table 1a.

### EXAMPLE 2

Retrofit replacements for HFC-134a in the air conditioning unit of Example 1 were also modelled under same operating conditions as for HFC-134a. Their compositions are shown in columns 2 to 6, Table 1a and Table 1b. Since all the blends are zeotropic their midpoint condensing and evaporating temperatures, 45° C. and 7° C. respectively, were chosen to provide a realistic comparison with HFC-134a. The key operating parameters, energy efficiency (i.e., coefficient of performance, COP), suction specific volume (a measure of cooling capacity) and compressor discharge temperature, were similar to those of HFC-134a, indicating the blends are acceptable retrofit replacements. Furthermore, their mass flow rates were similar to that of HFC-134a, so no changes to pipework would be required.

### EXAMPLE 3

As a comparative example, a mobile air conditioning (MAC) unit containing HFC-134a and operating on a Rankine cycle with an open compressor was modelled using a cycle based on NIST's REFPROP 10.0 database. The cycle input parameters were the following:
Condensing temperature 45° C.
Liquid subcool 5K
Evaporating temperature 7° C.
Suction super heat 5K
Compressor isentropic efficiency 0.75

The results are summarised in Table 2.

### EXAMPLE 4

Retrofit replacements for HFC-134a in the MAC unit of Example 3 were also modelled under same operating conditions as for HFC-134a. Their compositions are shown in columns Tables 3a to 3e columns 1 to 18, Table 4 columns 1 to 4 and Table 5a and b columns 1 to 8. Since all the blends are zeotropic their midpoint condensing and evaporating temperatures, 45° C. and 7° C. respectively, were chosen to provide a realistic comparison with HFC-134a. The key operating parameters, energy efficiency (i.e., coefficient of performance, COP), suction specific volume (a measure of cooling capacity) and compressor discharge temperature, were similar to those of HFC-134a. indicating the blends are acceptable retrofit replacements. Furthermore, their mass flow rates were similar to that of HFC-134a. so no changes to pipework would be required.

TABLE 1a

| | | 1 | 2 | 3 |
|---|---|---|---|---|
| Composition (mass fraction) | | | | |
| R134a | | 1 | 0 | 0 |
| CO2 | | 0 | 0.035 | 0.05 |
| R227ea | | 0 | 0.08 | 0.08 |
| R1234ze(E) | | 0 | 0.885 | 0.87 |
| GWP | | 1430 | 264 | 264 |
| Input | | | | |
| Cooling duty | kW | 1 | 1 | 1 |
| Condenser | | | | |
| Midpoint | C. | 45 | 45 | 45 |
| Subcool | K | 5 | 5 | 5 |
| Exit temperature | C. | 35 | 35 | 35 |
| Evaporator | | | | |
| Dew point | C. | 7 | 7 | 7 |
| Superheat | C. | 5 | 5 | 5 |
| Compressor | | | | |
| Isentropic efficiency | | 0.75 | 0.75 | 0.75 |
| Electric motor efficiency | | 0.9 | 0.9 | 0.9 |
| Output Condenser | | | | |
| Pressure | bara | 11.6 | 11.3 | 12.4 |
| Dew point | C. | 45 | 51.2 | 53.2 |
| Bubble point | C. | 45 | 38.8 | 36.8 |
| Midpoint | C. | 45 | 45 | 45 |
| Glide | K | 0 | 12.4 | 16.4 |
| Exit temperature | C. | 40 | 33.8 | 31.8 |
| Heat out | kW | 1.242 | 1.249 | 1.25 |
| Evaporator | | | | |
| Pressure | bara | 3.75 | 3.35 | 3.63 |
| Entry temperature | C. | 7 | 4.25 | 3.02 |
| Dew point | C. | 7 | 9.75 | 10.98 |
| Midpoint | C. | 7 | 7 | 7 |
| Glide | K | 0 | 5.5 | 8 |
| Exit temperature | C. | 12 | 14.8 | 16 |
| Heat in | kW | 1 | 1 | 1 |
| Compressor | | | | |
| Entry temperature to casing | C. | 12 | 14.8 | 16 |
| Entry temperature to compressor | C. | 16 | 18.8 | 20.1 |
| Discharge temperature | C. | 64.8 | 66.3 | 69.4 |
| Compression ratio | | 3.1 | 3.4 | 3.4 |
| Total power input | kW | 0.242 | 0.249 | 0.25 |
| System | | | | |
| Suction specific volume | kJ/m\hat{ }3 | 2375 | 2206 | 2404 |
| COP cooling | | 4.13 | 4.01 | 4 |
| Mass flow rate | kg/s | 0.00663 | 0.00679 | 0.00657 |

TABLE 1b

| | | 4 | 5 | 6 |
|---|---|---|---|---|
| Composition (mass fraction) | | | | |
| R125 | | 0.03 | 0.03 | 0 |
| CO2 | | 0.02 | 0.02 | 0.035 |
| R227ea | | 0.11 | 0.08 | 0.12 |
| R1234ze(E) | | 0.81 | 0.84 | 0.845 |
| R32 | | 0.03 | 0.03 | 0 |
| GWP | | 485 | 389 | 392 |
| Input | | | | |
| Cooling duty | kW | 1 | 1 | 1 |
| Condenser | | | | |
| Midpoint | C. | 45 | 45 | 45 |
| Subcool | K | 5 | 5 | 5 |
| Exit temperature | C. | 35 | 35 | 35 |
| Evaporator | | | | |
| Dew point | C. | 7 | 7 | 7 |
| Superheat | C. | 5 | 5 | 5 |
| Compressor | | | | |
| Isentropic efficiency | | 0.75 | 0.75 | 0.75 |
| Electric motor efficiency | | 0.9 | 0.9 | 0.9 |
| Output Condenser | | | | |
| Pressure | bara | 11.6 | 11.6 | 11.3 |
| Dew point | C. | 50.4 | 50.4 | 51.1 |
| Bubble point | C. | 39.6 | 39.6 | 38.9 |
| Midpoint | C. | 45 | 45 | 45 |
| Glide | K | 10.8 | 10.8 | 12.3 |
| Exit temperature | C. | 34.6 | 34.6 | 33.9 |
| Heat out | kW | 1.247 | 1.247 | 1.249 |
| Evaporator | | | | |
| Pressure | bara | 3.55 | 3.54 | 3.36 |
| Entry temperature | C. | 3.97 | 3.99 | 4.27 |
| Dew point | C. | 10.03 | 10.01 | 9.73 |
| Midpoint | C. | 7 | 7 | 7 |
| Glide | K | 6.1 | 6 | 5.5 |
| Exit temperature | C. | 15 | 15 | 14.7 |
| Heat in | kW | 1 | 1 | 1 |
| Compressor | | | | |
| Entry temperature to casing | C. | 15 | 15 | 14.7 |
| Entry temperature to compressor | C. | 18.9 | 18.9 | 18.7 |
| Discharge temperature | C. | 65.7 | 66 | 65.8 |
| Compression ratio | | 3.3 | 3.3 | 3.4 |
| Total power input | kW | 0.247 | 0.247 | 0.249 |
| System | | | | |
| Suction specific volume | kJ/m\hat{ }3 | 2288 | 2287 | 2203 |
| COP cooling | | 4.05 | 4.05 | 4.01 |
| Mass flow rate | kg/s | 0.00695 | 0.00687 | 0.0069 |

TABLE 2

| | | R134a |
|---|---|---|
| GWP | | 1300 |
| Input Condenser | | |
| Midpoint | C. | 45 |
| Subcool | K | 5 |
| Evaporator | | |
| Midpoint | C. | 7 |
| Superheat | K | 5 |
| Compressor | | |
| Isentropic efficiency | | 0.7 |
| Output Condenser | | |
| Entry temperature | C. | 62.89 |
| Pressure | | |
| Dew point | bara | 11.60 |
| Mid point | C. | 45.00 |
| Glide | C. | 45.00 |
| Enthalpy loss | K | 0.00 |
| Evaporator | | |
| Entry pressure | kW/kg | 0.00 |
| Entry temperature | bara | 3.75 |
| Midpoint | C. | 7.00 |
| Glide | C. | 7.00 |
| Exit pressure | C. | 0.00 |
| Enthalpy gain | bara | 3.75 |
| Compressor | | |
| Entry temperature to | kWc/kg | 150.87 |
| compressor | | |
| Discharge temperature | C. | 12.0 |
| Compression ratio P/P | C. | 62.9 |
| System | | |
| Suction specific | kJ/m\hat{ }3 · kg | 3.10 |
| volume | | |
| COP cooling | | 2692 |
| Mass flow rate | | 4.38 |

TABLE 3a

| | | 1 | 2 | 3 | 4 |
|---|---|---|---|---|---|
| Composition (mass fraction) | | | | | |
| carbon dioxide | | 0.035 | 0.035 | 0.035 | 0.035 |
| R1234zee | | 0.885 | 0.875 | 0.865 | 0.855 |
| R227ea | | 0.08 | 0.09 | 0.1 | 0.11 |
| GWP | | 261 | 293 | 325 | 357 |
| Input Condenser | | | | | |
| Midpoint | C. | 45 | 45 | 45 | 45 |
| Subcool | K | 5 | 5 | 5 | 5 |
| Evaporator | | | | | |
| Midpoint | C. | 7 | 7 | 7 | 7 |
| Superheat | K | 5 | 5 | 5 | 5 |
| Compressor | | | | | |
| Isentropic efficiency | | 0.7 | 0.7 | 0.7 | 0.7 |
| Output Condenser | | | | | |
| Entry temperature | C. | 64.67 | 64.60 | 64.54 | 64.47 |
| Pressure | bara | 11.32 | 11.33 | 11.33 | 11.33 |
| Dew point | C. | 51.42 | 51.45 | 51.48 | 51.50 |
| Mid point | C. | 45.00 | 45.00 | 45.00 | 45.00 |
| Glide | K | 12.83 | 12.89 | 12.95 | 13.01 |
| Enthalpy loss | kW/kg | 0.00 | 0.00 | 0.00 | 0.00 |
| Evaporator | | | | | |
| Entry pressure | bara | 3.33 | 3.33 | 3.33 | 3.33 |
| Entry temperature | C. | 4.18 | 4.17 | 4.16 | 4.15 |
| Midpoint | C. | 7.00 | 7.00 | 7.00 | 7.00 |
| Glide | C. | 5.65 | 5.67 | 5.69 | 5.70 |
| Exit pressure | bara | 3.33 | 3.33 | 3.33 | 3.33 |
| Enthalpy gain | kWc/kg | 148.00 | 147.50 | 147.01 | 146.52 |
| Compressor | | | | | |
| Entry temperature to compressor | C. | 14.8 | 14.8 | 14.8 | 14.9 |
| Discharge temperature | C. | 64.7 | 64.6 | 64.5 | 64.5 |
| Compression ratio P/P | | 3.40 | 3.40 | 3.40 | 3.40 |
| System | | | | | |
| Suction specific volume | kJ/m\hat{ }3 | 2492 | 2491 | 2490 | 2490 |
| COP cooling | | 4.25 | 4.25 | 4.24 | 4.24 |
| Mass flow rate | kg/kWc | 0.00676 | 0.00678 | 0.00680 | 0.00683 |

TABLE 3b

| | | 5 | 6 | 7 | 8 |
|---|---|---|---|---|---|
| Composition (mass fraction) | | | | | |
| carbon dioxide | | 0.035 | 0.035 | 0.035 | 0.035 |
| R1234zee | | 0.845 | 0.835 | 0.825 | 0.815 |
| R227ea | | 0.12 | 0.13 | 0.14 | 0.15 |
| GWP | | 389 | 421 | 453 | 485 |
| Input Condenser | | | | | |
| Midpoint | C. | 45 | 45 | 45 | 45 |
| Subcool | K | 5 | 5 | 5 | 5 |
| Evaporator | | | | | |
| Midpoint | C. | 7 | 7 | 7 | 7 |
| Superheat | K | 5 | 5 | 5 | 5 |
| Compressor | | | | | |
| Isentropic efficiency | | 0.7 | 0.7 | 0.7 | 0.7 |
| Output Condenser | | | | | |
| Entry temperature | C. | 64.40 | 64.33 | 64.27 | 64.20 |
| Pressure | bara | 11.34 | 11.34 | 11.35 | 11.35 |
| Dew point | C. | 51.53 | 51.56 | 51.59 | 51.62 |
| Mid point | C. | 45.00 | 45.00 | 45.00 | 45.00 |
| Glide | K | 13.07 | 13.13 | 13.18 | 13.24 |
| Enthalpy loss | kW/kg | 0.00 | 0.00 | 0.00 | 0.00 |
| Evaporator | | | | | |
| Entry pressure | bara | 3.33 | 3.33 | 3.33 | 3.33 |
| Entry temperature | C. | 4.14 | 4.13 | 4.12 | 4.11 |
| Midpoint | C. | 7.00 | 7.00 | 7.00 | 7.00 |
| Glide | C. | 5.72 | 5.74 | 5.76 | 5.78 |
| Exit pressure | bara | 3.33 | 3.33 | 3.33 | 3.33 |
| Enthalpy gain | kWc/kg | 146.02 | 145.53 | 145.03 | 144.53 |
| Compressor | | | | | |
| Entry temperature to compressor | C. | 14.9 | 14.9 | 14.9 | 14.9 |
| Discharge temperature | C. | 64.4 | 64.3 | 64.3 | 64.2 |
| Compression ratio P/P | | 3.40 | 3.41 | 3.41 | 3.41 |
| System | | | | | |
| Suction specific volume | kJ/m\hat{ }3 | 2489 | 2488 | 2487 | 2486 |
| COP cooling | | 4.24 | 4.24 | 4.24 | 4.24 |
| Mass flow rate | kg/kWc | 0.00685 | 0.00687 | 0.00690 | 0.00692 |

TABLE 3c

| | | 9 | 10 | 11 |
|---|---|---|---|---|
| Composition (mass fraction) | | | | |
| carbon dioxide | | 0.05 | 0.05 | 0.05 |
| R1234zee | | 0.83 | 0.9 | 0.89 |
| R227ea | | 0.12 | 0.05 | 0.06 |
| GWP | | 389 | 165 | 197 |
| Input Condenser | | | | |
| Midpoint | C. | 45 | 45 | 45 |
| Subcool | K | 5 | 5 | 5 |
| Evaporator | | | | |
| Midpoint | C. | 7 | 7 | 7 |
| Superheat | K | 5 | 5 | 5 |
| Compressor | | | | |
| Isentropic efficiency | | 0.7 | 0.7 | 0.7 |
| Output Condenser | | | | |
| Entry temperature | C. | 67.51 | 67.92 | 67.86 |
| Pressure | bara | 12.46 | 12.39 | 12.40 |
| Dew point | C. | 53.62 | 53.36 | 53.40 |
| Mid point | C. | 45.00 | 45.00 | 45.00 |
| Glide | K | 17.23 | 16.72 | 16.80 |
| Enthalpy loss | kW/kg | 0.00 | 0.00 | 0.00 |
| Evaporator | | | | |
| Entry pressure | bara | 3.62 | 3.61 | 3.61 |
| Entry temperature | C. | 2.86 | 2.96 | 2.94 |
| Midpoint | C. | 7.00 | 7.00 | 7.00 |
| Glide | C. | 8.28 | 8.08 | 8.11 |
| Exit pressure | bara | 3.62 | 3.61 | 3.61 |
| Enthalpy gain | kW/kg | 150.97 | 154.39 | 153.90 |
| Compressor | | | | |
| Entry temperature to compressor | C. | 16.1 | 16.0 | 16.1 |
| Discharge temperature | C. | 67.5 | 67.9 | 67.9 |
| Compression ratio P/P | | 3.44 | 3.43 | 3.43 |
| System | | | | |
| Suction specific volume | kJ/m\hat{ }3 | 2722 | 2722 | 2722 |
| COP cooling | | 4.23 | 4.24 | 4.24 |
| Mass flow rate | kg/kWc | 0.00662 | 0.00648 | 0.00650 |

TABLE 3d

| | | 12 | 13 | 14 | 15 |
|---|---|---|---|---|---|
| Composition (mass fraction) | | | | | |
| carbon dioxide | | 0.05 | 0.05 | 0.05 | 0.05 |
| R1234zee | | 0.88 | 0.87 | 0.86 | 0.85 |
| R227ea | | 0.07 | 0.08 | 0.09 | 0.1 |
| GWP | | 229 | 261 | 293 | 325 |
| Input Condenser | | | | | |
| Midpoint | C. | 45 | 45 | 45 | 45 |
| Subcool | K | 5 | 5 | 5 | 5 |
| Evaporator | | | | | |
| Midpoint | C. | 7 | 7 | 7 | 7 |
| Superheat | K | 5 | 5 | 5 | 5 |
| Compressor | | | | | |
| Isentropic efficiency | | 0.7 | 0.7 | 0.7 | 0.7 |
| Output Condenser | | | | | |
| Entry temperature | C. | 67.80 | 67.74 | 67.68 | 67.63 |
| Pressure | bara | 12.41 | 12.42 | 12.43 | 12.44 |
| Dew point | C. | 53.44 | 53.47 | 53.51 | 53.54 |
| Mid point | C. | 45.00 | 45.00 | 45.00 | 45.00 |
| Glide | K | 16.87 | 16.94 | 17.02 | 17.09 |
| Enthalpy loss | kW | 0.00 | 0.00 | 0.00 | 0.00 |
| Evaporator | | | | | |
| Entry pressure | bara | 3.61 | 3.61 | 3.61 | 3.62 |
| Entry temperature | C. | 2.93 | 2.92 | 2.90 | 2.89 |
| Midpoint | C. | 7.00 | 7.00 | 7.00 | 7.00 |
| Glide | C. | 8.14 | 8.17 | 8.20 | 8.23 |
| Exit pressure | bara | 3.61 | 3.61 | 3.61 | 3.62 |
| Enthalpy gain | kWc | 153.41 | 152.92 | 152.44 | 151.95 |
| Compressor | | | | | |
| Entry temperature to compressor | C. | 16.1 | 16.1 | 16.1 | 16.1 |
| Discharge temperature | C. | 67.8 | 67.7 | 67.7 | 67.6 |
| Compression ratio P/P | | 3.43 | 3.44 | 3.44 | 3.44 |
| System | | | | | |
| Suction specific volume | kJ/m\hat{ }3 | 2722 | 2722 | 2722 | 2722 |
| COP cooling | | 4.24 | 4.23 | 4.23 | 4.23 |
| Mass flow rate | kg/kWc | 0.00652 | 0.00654 | 0.00656 | 0.00658 |

TABLE 3e

| | | 16 | 17 | 18 |
|---|---|---|---|---|
| Composition (mass fraction) | | | | |
| CO2 | | 0.05 | 0.05 | 0.05 |
| R1234zee | | 0.86 | 0.85 | 0.84 |
| R227ea | | 0.09 | 0.1 | 0.11 |
| GWP | | 293 | 325 | 357 |
| Input Condenser | | | | |
| Midpoint | C. | 45 | 45 | 45 |
| Subcool | K | 5 | 5 | 5 |
| Evaporator | | | | |
| Midpoint | C. | 7 | 7 | 7 |
| Superheat | K | 5 | 5 | 5 |
| Compressor | | | | |
| Isentropic efficiency | | 0.7 | 0.7 | 0.7 |
| Output Condenser | | | | |
| Entry temperature | C. | 69.13 | 69.24 | 69.36 |
| Pressure | bara | 12.70 | 12.74 | 12.79 |
| Dew point | C. | 53.77 | 53.84 | 53.91 |
| Mid point | C. | 45.00 | 45.00 | 45.00 |
| Glide | K | 17.54 | 17.68 | 17.83 |
| Enthalpy loss | kWc/kg | 188.31 | 188.53 | 188.76 |
| Evaporator | | | | |
| Entry pressure | bara | 3.71 | 3.72 | 3.73 |
| Entry temperature | C. | 2.63 | 2.58 | 2.53 |
| Midpoint | C. | 7.00 | 7.00 | 7.00 |
| Glide | C. | 8.73 | 8.83 | 8.93 |
| Exit pressure | bara | 3.71 | 3.72 | 3.73 |
| Enthalpy gain | kWc/kg | 158.34 | 158.52 | 158.71 |
| Compressor | | | | |
| Entry temperature to compressor | C. | 16.4 | 16.4 | 16.5 |
| Discharge temperature | C. | 69.1 | 69.2 | 69.4 |
| Compression ratio P/P | | 3.43 | 3.43 | 3.43 |
| System | | | | |
| Suction specific volume | kJ/m\hat{ }3 | 2796 | 2806 | 2815 |
| COP cooling | | 4.24 | 4.24 | 4.24 |
| Mass flow rate | kg/kWc | 0.00632 | 0.00631 | 0.00630 |

TABLE 4

| | | 1 | 2 | 3 | 4 |
|---|---|---|---|---|---|
| Composition (mass fraction) | | | | | |
| CO2 | | 0.05 | 0.05 | 0.05 | 0.05 |
| R1234zee | | 0.81 | 0.82 | 0.81 | 0.79 |
| R32 | | 0.03 | 0.03 | 0.02 | 0.05 |
| R227ea | | 0.08 | 0.07 | 0.1 | 0.06 |
| R125 | | 0.03 | 0.03 | 0.02 | 0.05 |
| GWP | | 386 | 354 | 408 | 406 |
| Input Condenser | | | | | |
| Midpoint | C. | 45 | 45 | 45 | 45 |
| Subcool | K | 5 | 5 | 5 | 5 |
| Evaporator | | | | | |
| Midpoint | C. | 7 | 7 | 7 | 7 |
| Superheat | K | 5 | 5 | 5 | 5 |
| Compressor | | | | | |
| Isentropic efficiency | | 0.7 | 0.7 | 0.7 | 0.7 |
| Output Condenser | | | | | |
| Entry temperature | C. | 69.78 | 69.84 | 69.03 | 71.05 |
| Pressure | bara | 13.58 | 13.57 | 13.22 | 14.31 |
| Dew point | C. | 54.07 | 54.04 | 53.98 | 54.21 |
| Mid point | C. | 45.00 | 45.00 | 45.00 | 45.00 |
| Glide | K | 18.14 | 18.07 | 17.97 | 18.42 |
| Enthalpy loss | kWc/kg | 184.98 | 185.58 | 182.82 | 187.94 |
| Evaporator | | | | | |
| Entry pressure | bara | 4.04 | 4.04 | 3.90 | 4.33 |
| Entry temperature | C. | 1.84 | 1.86 | 2.14 | 1.33 |
| Midpoint | C. | 7.00 | 7.00 | 7.00 | 7.00 |
| Glide | C. | 10.31 | 10.28 | 9.73 | 11.35 |
| Exit pressure | bara | 4.04 | 4.04 | 3.90 | 4.33 |
| Enthalpy gain | kWc/kg | 155.70 | 156.20 | 153.86 | 158.23 |
| Compressor | | | | | |
| Entry temperature to compressor | C. | 17.2 | 17.1 | 16.9 | 17.7 |
| Discharge temperature | C. | 69.8 | 69.8 | 69.0 | 71.0 |
| Compression ratio P/P | | 3.36 | 3.36 | 3.39 | 3.31 |
| System | | | | | |
| Suction specific volume | kJ/m\hat{ }3 | 3006 | 3005 | 2913 | 3188 |
| COP cooling | | 4.25 | 4.25 | 4.25 | 4.26 |
| Mass flow rate | kg/kWc | 0.00642 | 0.00640 | 0.00650 | 0.00632 |

TABLE 5a

| | | 1 | 2 | 3 |
|---|---|---|---|---|
| Composition (mass fraction) | | | | |
| CO2 | | 0.05 | 0.05 | 0.05 |
| R1234zee | | 0.85 | 0.87 | 0.86 |
| R32 | | 0.03 | 0.02 | 0.03 |
| R227ea | | 0.04 | 0.04 | 0.03 |
| R125 | | 0.03 | 0.02 | 0.03 |
| R134a | | 0.04 | 0.04 | 0.05 |
| GWP | | 258 | 217 | 226 |
| Input Condenser | | | | |
| Midpoint | C. | 45 | 45 | 45 |
| Subcool | K | 5 | 5 | 5 |
| Evaporator | | | | |
| Midpoint | C. | 7 | 7 | 7 |
| Superheat | K | 5 | 5 | 5 |
| Compressor | | | | |
| Isentropic efficiency | | 0.7 | 0.7 | 0.7 |
| Output Condenser | | | | |
| Entry temperature | C. | 70.12 | 69.51 | 70.21 |
| Pressure | bara | 13.69 | 13.31 | 13.71 |
| Dew point | C. | 53.79 | 53.65 | 53.72 |
| Mid point | C. | 45.00 | 45.00 | 45.00 |
| Glide | K | 17.58 | 17.29 | 17.45 |
| Enthalpy loss | kWc/kg | 187.40 | 186.42 | 188.01 |
| Evaporator | | | | |
| Entry pressure | bara | 4.09 | 3.95 | 4.11 |
| Entry temperature | C. | 1.96 | 2.26 | 1.99 |
| Midpoint | C. | 7.00 | 7.00 | 7.00 |
| Glide | C. | 10.09 | 9.48 | 10.03 |
| Exit pressure | bara | 4.09 | 3.95 | 4.11 |
| Enthalpy gain | kWc/kg | 157.73 | 156.89 | 158.24 |
| Compressor | | | | |
| Entry temperature to compressor | C. | 17.0 | 16.7 | 17.0 |
| Discharge temperature | C. | 70.1 | 69.5 | 70.2 |
| Compression ratio P/P | | 3.34 | 3.37 | 3.34 |
| System | | | | |
| Suction specific volume | kJ/m\hat{ }3 | 3038 | 2946 | 3046 |
| COP cooling | | 4.26 | 4.25 | 4.26 |
| Mass flow rate | kg/kWc | 0.00634 | 0.00637 | 0.00632 |

TABLE 5b

| | | 4 | 5 | 6 |
|---|---|---|---|---|
| Composition (mass fraction) | | | | |
| CO2 | | 0.05 | 0.05 | 0.05 |
| R1234zee | | 0.83 | 0.81 | 0.82 |
| R32 | | 0.03 | 0.05 | 0.05 |
| R227ea | | 0.06 | 0.04 | 0.03 |
| R125 | | 0.03 | 0.05 | 0.05 |
| R134a | | 0.02 | 0.04 | 0.05 |
| GWP | | 322 | 341 | 309 |
| Input Condenser | | | | |
| Midpoint | C. | 45 | 45 | 45 |
| Subcool | K | 5 | 5 | 5 |
| Evaporator | | | | |
| Midpoint | C. | 7 | 7 | 7 |
| Superheat | K | 5 | 5 | 5 |
| Compressor | | | | |
| Isentropic efficiency | | 0.7 | 0.7 | 0.7 |
| Output Condenser | | | | |
| Entry temperature | C. | 69.95 | 71.25 | 71.33 |
| Pressure | bara | 13.63 | 14.43 | 14.46 |
| Dew point | C. | 53.93 | 53.98 | 53.91 |
| Mid point | C. | 45.00 | 45.00 | 45.00 |
| Glide | K | 17.86 | 17.96 | 17.82 |
| Enthalpy loss | kWc/kg | 186.19 | 189.16 | 189.77 |
| Evaporator | | | | |
| Entry pressure | bara | 4.07 | 4.38 | 4.39 |
| Entry temperature | C. | 1.90 | 1.44 | 1.48 |
| Midpoint | C. | 7.00 | 7.00 | 7.00 |
| Glide | C. | 10.20 | 11.12 | 11.04 |
| Exit pressure | bara | 4.07 | 4.38 | 4.39 |
| Enthalpy gain | kWc/kg | 156.71 | 159.24 | 159.75 |
| Compressor | | | | |
| Entry temperature to compressor | C. | 17.1 | 17.6 | 17.5 |
| Discharge temperature | C. | 70.0 | 71.2 | 71.3 |
| Compression ratio P/P | | 3.35 | 3.30 | 3.29 |
| System | | | | |
| Suction specific volume | kJ/m\hat{ }3 | 3022 | 3219 | 3226 |
| COP cooling | | 4.26 | 4.26 | 4.26 |
| Mass flow rate | kg/kWc | 0.00638 | 0.00628 | 0.00626 |

1. A refrigerant composition comprising:
Carbon dioxide 1-7%
Hydrofluoroolefin (HFO)-1234ze(E) 70-97%,
HFC-227ea 2-16%; and
0-27% of an optional component selected from the group consisting of:
HFC-32, HFC-134a, R125 and mixtures thereof,
wherein the percentages of the components are by mass and are selected from the ranges quoted to total 100%.

2. A refrigerant composition according to claim 1 which has a safety classification of A1 according to ASHRAE.

3. A refrigerant composition according to claim 1 which has a maximum Global Warming Potential of 500 on a 100-year Integrated Time Horizon.

4. A refrigerant composition as claimed in claim 1 comprising:
Carbon dioxide 1-6%
R1234ze(E) 75-95%
R227ea 5-15%; and
0-19% of an optional component selected from the group consisting of:
HFC-32, HFC-134a, R125 and mixtures thereof,
wherein the percentages of the components are by mass and are selected from the ranges quoted to total 100%.

5. A refrigerant composition as claimed in claim 4 comprising:
Carbon dioxide 2-6%
R1234ze(E) 77-94%
R227ea 5-13%; and
0-16% of an optional component selected from the group consisting of:
HFC-32, HFC-134a, R125 and mixtures thereof,
wherein the percentages of the components are by mass and are selected from the ranges quoted to total 100%.

6. A refrigerant composition as claimed in claim 5 comprising:
Carbon dioxide 2-6%
R1234ze(E) 80-93%
R227ea 7-13%; and
0-11% of an optional component selected from the group consisting of:
HFC-32, HFC-134a, R125 and mixtures thereof,
wherein the percentages of the components are by mass and are selected from the ranges quoted to total 100%.

7. A refrigerant composition as claimed in claim 6 comprising:
Carbon dioxide 2-5%
R1234ze(E) 80-93%
R227ea 7-12%; and
0-11% of an optional component selected from the group consisting of:
HFC-32, HFC-134a, R125 and mixtures thereof,
wherein the percentages of the components are by mass and are selected from the ranges quoted to total 100%.

8. A refrigerant composition as claimed in claim 1 comprising:
Carbon dioxide 1-3.5%
Hydrofluoroolefin (HFO)-1234ze 75-93%,
HFC-227ea 7-12%
HFC-32 1-5%
HFC-125 1-5%
HFC-134a 1-5%
wherein the percentages of the components are by mass and are selected from the ranges quoted to total 100%.

9. A refrigerant composition as claimed in claim 1 comprising:
Carbon dioxide 3-6%
R1234ze(E) 89-90%
R227ea 7-13%
0-1% of an optional component selected from the group consisting of:
HFC-32, HFC-134a, R125 and mixtures thereof,
wherein the percentages of the components are by mass and are selected from the ranges quoted to total 100%.

10. A refrigerant composition as claimed in claim 1 comprising:
Carbon dioxide 3-6%
R1234ze(E) 81-89%
R227ea 8-13%
0-8% of an optional component selected from the group consisting of:
HFC-32, HFC-134a, R125 and mixtures thereof,
wherein the percentages of the components are by mass and are selected from the ranges quoted to total 100%.

11. A refrigerant composition as claimed in claim 1 consisting of:
Carbon dioxide 3.5%
R1234ze(E) 88.5%
R227ea 8%

12. A refrigerant composition as claimed in claim 1 consisting of:
Carbon dioxide 5%
R1234ze(E) 87%
R227ea 8%

13. A refrigerant composition as claimed in claim 1 consisting of:
Carbon dioxide 5%
R1234ze(E) 86%
R227ea 9%

14. A refrigerant composition as claimed in claim 1 consisting of:
Carbon dioxide 5%
R1234ze(E) 85%
R227ea 10%

15. A refrigerant composition as claimed in claim 1 consisting of:
R125 3%
Carbon dioxide 2%
R1234ze(E) 81%
R227ea 11%
R32 3%

16. A refrigerant composition as claimed in claim 1 consisting of:
Carbon dioxide 3.5%
R1234ze 84.5%
R227ea 12%

17. A refrigerant composition as claimed in claim 1 consisting of:
Carbon dioxide 2%
R1234ze 82%
R227ea 6%
R125 3%
R32 2%
R134a 5%

18. A refrigerant composition as claimed in claim 1 consisting of:
Carbon dioxide 1%
R1234ze 83%
R227ea 6%
R125 2%
R32 3%
R134a 5%

19. Use of a refrigerant composition as claimed in claim 1 as an extender for R134a.
